(19) United States
(12) Patent Application Publication
(10) Pub. No.: US 2020/0276929 A1
(43) Pub. Date: Sep. 3, 2020

(54) SUPPORT SYSTEM FOR SECURING HORIZONTAL LOGISTICS TRACK TO CARGO COMPARTMENT VERTICAL LOGISTICS POSTS

(71) Applicant: Ancra International LLC, Azusa, CA (US)

(72) Inventors: H. Thomas Knox, Cold Spring, KY (US); Gregory Alan Kauffman, Cincinnati, OH (US)

(73) Assignee: Ancra International LLC, Azusa, CA (US)

(21) Appl. No.: 16/802,881

(22) Filed: Feb. 27, 2020

Related U.S. Application Data
(60) Provisional application No. 62/812,399, filed on Mar. 1, 2019.

(51) Int. Cl. B60P 7/15; F16M 13/02

(52) U.S. Cl. CPC B60P 7/15; F16M 13/02

(57) ABSTRACT

A plate for supporting and securing a track to adjacent first and second vertical logistics posts may be configured such that the plate is capable of being secured to adjacent first and second vertical logistics posts while leaving first and second slots of the respective adjacent first and second vertical logistics posts that are in line with a third section of the plate open.

### PRIORITY CLAIM

This invention claims the benefit of priority of U.S. Provisional Application Ser. No. 62/812,399, entitled “Support System for Securing Horizontal Logistics Track to Cargo Compartment Vertical Logistics Posts,” filed Mar. 1, 2019, the disclosure of which is hereby incorporated by reference in its entirety.

### TECHNICAL FIELD

The present disclosure relates to a support system for supporting and securing components of a logistics track system to adjacent vertical logistics posts that are installed on a sidewall of a cargo compartment. The components, such as a horizontal logistics track may be configured to support beams used for shoring or decking between the vertical logistics posts that are installed on opposite sidewalls of the cargo compartment. The support system may be easily installed and removed but still has the strength suitable to support the full loads of the components (e.g., the horizontal logistics track), beams coupled thereto, and the cargo disposed on the beams.

### BRIEF SUMMARY OF THE INVENTION

One general aspect of the present disclosure includes a plate for securing to adjacent first and second vertical logistics posts, including a first end section; a second end section; a third section extending between the first and second end sections; and a track secured to the third section, where the plate is configured such that when the plate is secured to adjacent first and second vertical logistics posts, the third section extends horizontally between first and second slots of the respective adjacent first and second vertical logistics posts, the first end section is secured to a third slot disposed adjacent to and above the first slot in the first vertical logistics post, and the second end section is secured to a fourth slot disposed adjacent to and below the second slot in the second vertical logistics post.

Another general aspect of the present disclosure includes a plate for supporting and securing a track to adjacent first and second vertical logistics posts, including a first end section; a second end section; and a third section extending between the first and second end sections, where the plate is configured such that when the plate is secured to the adjacent first and second vertical logistics posts, the third section extends horizontally between first and second slots of the respective adjacent first and second vertical logistics posts, and the first and second end sections are respectively secured to third and fourth slots of the respective adjacent first and second vertical logistics posts, where the third and fourth slots are disposed at different heights upon the respective adjacent first and second vertical logistics posts.

Another general aspect of the present disclosure includes a plate for supporting and securing a track to adjacent first and second vertical logistics posts, where the plate is configured such that the plate is capable of being secured to adjacent first and second vertical logistics posts while leaving first and second slots of the respective adjacent first and second vertical logistics posts that are in line with a third section of the plate open.

Other systems, methods, features and advantages of the invention will be, or will become, apparent to one with skill in the art upon examination of the following figures and detailed description. It is intended that all such additional systems, methods, features, and advantages be within the scope of the invention, and be encompassed by the following claims.

### BRIEF DESCRIPTION OF THE DRAWINGS

The present disclosure can be better understood with reference to the following drawings and description. The components in the figures are not necessarily to scale, emphasis instead being placed upon illustrating the principles of the present disclosure. Moreover, in the figures, like-referenced numerals designate corresponding parts throughout the different views.

FIG. 1 is a front perspective view of a support system with a horizontal logistics track mounted on a third section of a plate of the support system in accordance with certain aspects of the present disclosure.

FIG. 2 is an exploded perspective view of the support system of FIG. 1 in accordance with certain aspects of the present disclosure.

FIG. 3 is a front perspective view showing a plurality of the support systems of FIG. 1 with a horizontal logistics track mounted thereon are successively secured to respective adjacent vertical logistics posts mounted on a sidewall of a cargo compartment in accordance with certain aspects of the present disclosure.

FIG. 4 is a partially enlarged front perspective view showing that when the plurality of the support systems of FIG. 1 with a horizontal logistics track mounted thereon are successively secured to respective adjacent vertical logistics posts, a slot of the logistics post that is disposed between two adjacent support systems is in line with the horizontal logistics track and is open, in accordance with certain aspects of the present disclosure.

FIG. 5 is a partially enlarged exploded back perspective view of a first end section of the support system of FIG. 1 in accordance with certain aspects of the present disclosure.

FIG. 6 is a partially enlarged exploded front perspective view of the first end section of the support system of FIG. 5 in accordance with certain aspects of the present disclosure.

FIG. 7 is a partially enlarged back perspective view of the first end section of the support system of FIG. 5, showing two adapters and a locking engagement device are secured to the plate of the support system with a block disposed therebetween, in accordance with certain aspects of the present disclosure.

FIG. 8 is a back perspective view of the support system of FIG. 1 in accordance with certain aspects of the present disclosure.

FIG. 9 is another back perspective view of the support system of FIG. 1 in accordance with certain aspects of the present disclosure.

FIG. 10 is a partially enlarged front perspective view of a second end section of the support system of FIG. 1 in accordance with certain aspects of the present disclosure.

FIG. 11 is a front perspective view of another embodiment of a support system with a horizontal logistics track mounted on a third section of a plate of the support system in accordance with certain aspects of the present disclosure.

FIG. 12 is a back perspective view of the support system of FIG. 11 in accordance with certain aspects of the present disclosure.

FIG. 13 is a partially enlarged exploded perspective view of a second end section of the support system of FIG. 11.

FIG. 14a is a perspective view showing that a plurality of horizontal logistics tracks are successively secured to respective adjacent vertical logistics posts mounted on each of the opposite sidewalls of a cargo compartment through a plurality of support systems in accordance with certain aspects of the present disclosure.

FIG. 14b is a perspective view showing beams extending between the opposite sidewalls of the cargo compartment of FIG. 14a with ends secured to respective slots of the horizontal logistics tracks mounted between respective adjacent vertical logistics posts on the opposite sidewalls of the cargo compartment in accordance with certain aspects of the present disclosure.

FIG. 15 is a partially enlarged back perspective view showing that one end of the support system of FIG. 1 is secured to two adjacent slots in a vertical logistics post in accordance with certain aspects of the present disclosure.

FIG. 16 is a partially enlarged back perspective view showing that one end of the support system of FIG. 11 is secured to a single slot in a vertical logistics post in accordance with certain aspects of the present disclosure.

FIG. 17 is a front perspective view of an alternative embodiment of a support system in accordance with certain aspects of the present disclosure.

FIG. 18 is a back perspective view of the embodiment of FIG. 17.

FIG. 19 is an exploded perspective view of a first end region of the support system of FIG. 17.

FIG. 20 is an exploded perspective view of a second end region of the support system of FIG. 17.

### DETAILED DESCRIPTION

Various aspects are described below with reference to the drawings in which like elements generally are identified by like numerals. The relationship and functioning of the various elements of the aspects may better be understood by reference to the following detailed description. However, aspects are not limited to those illustrated in the drawings or explicitly described below. It also should be understood that the drawings are not necessarily to scale, and in certain instances details may have been omitted that are not necessary for an understanding of aspects disclosed herein, such as conventional material, construction, and assembly.

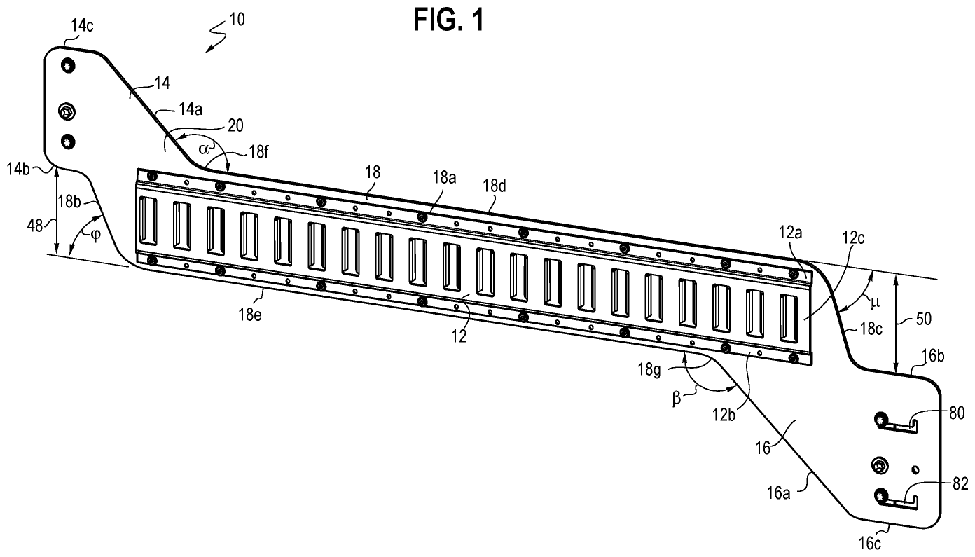

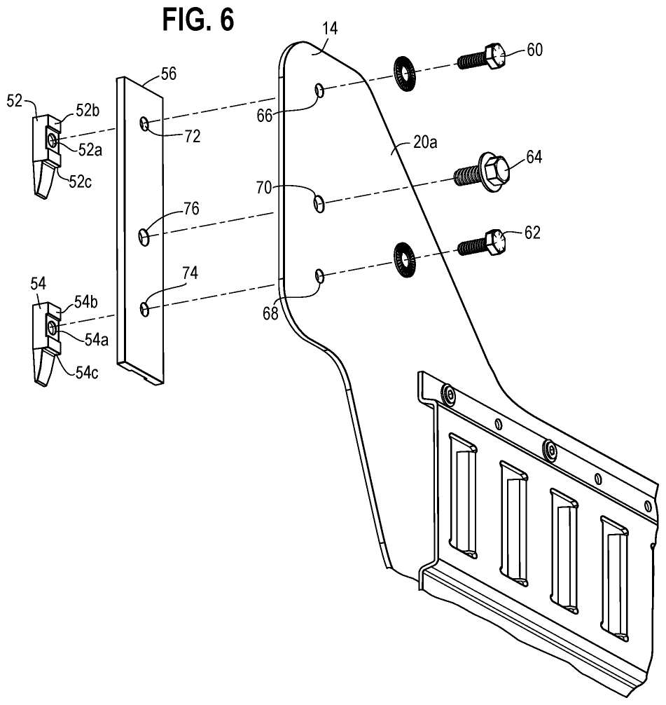

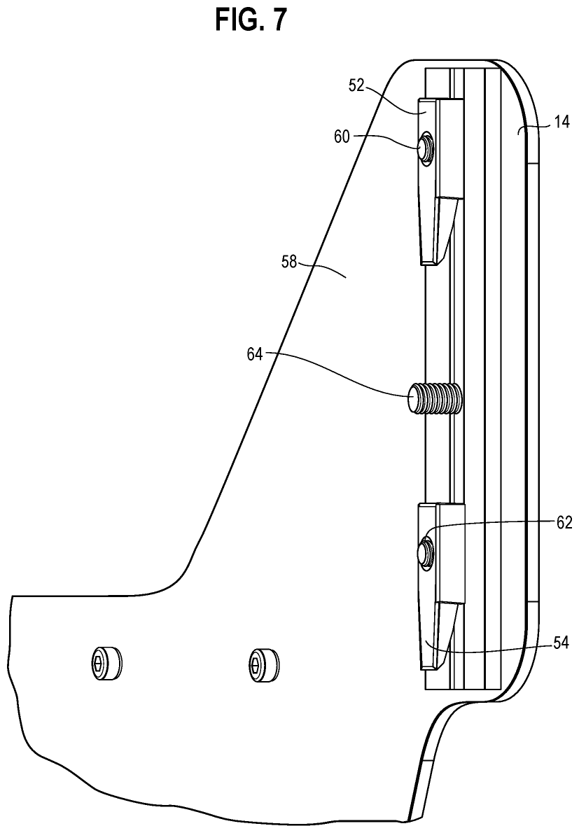

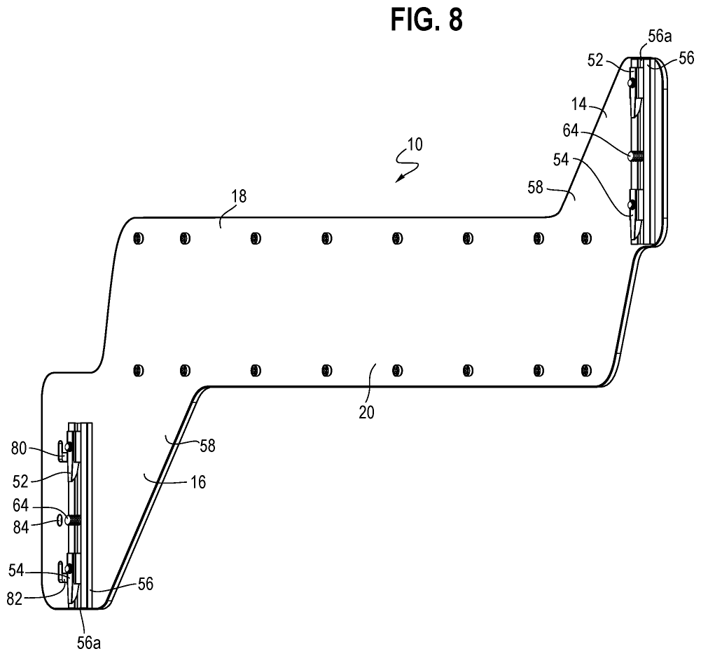

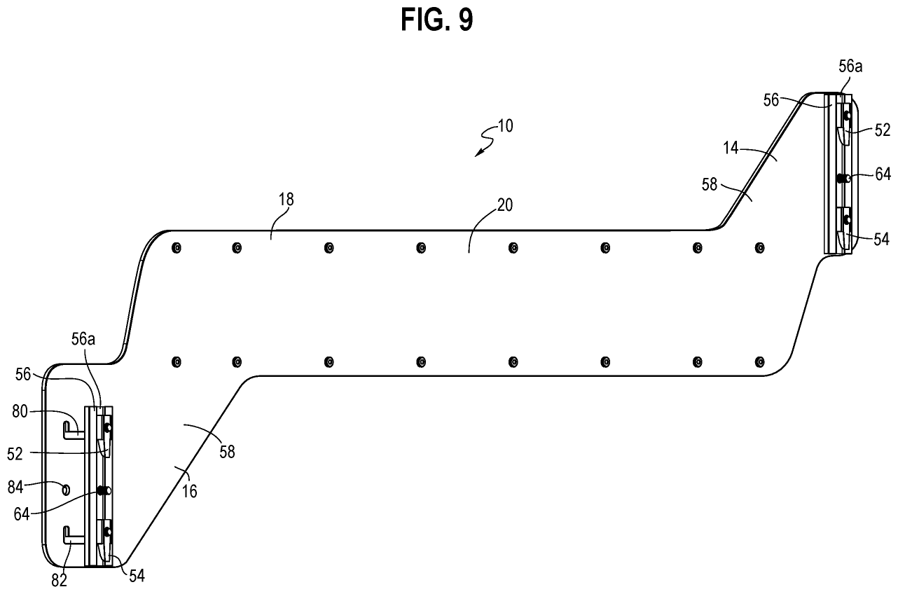

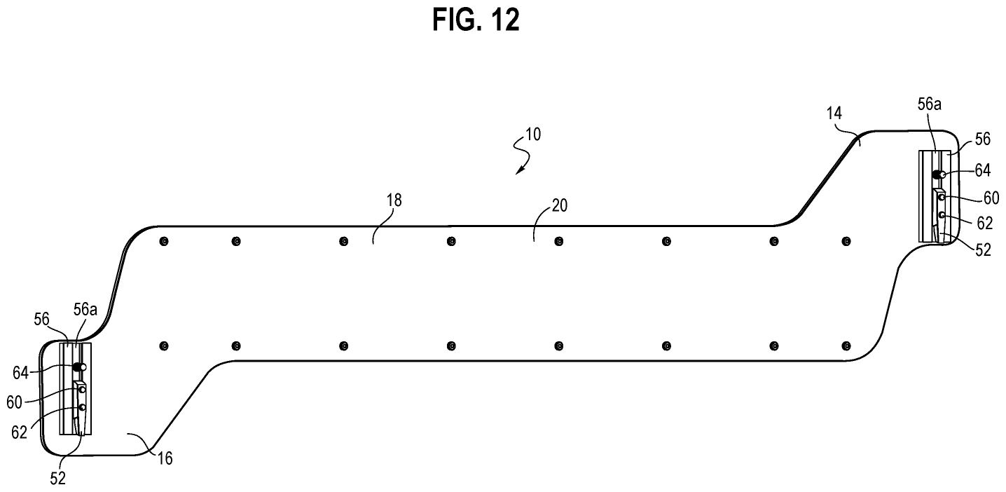

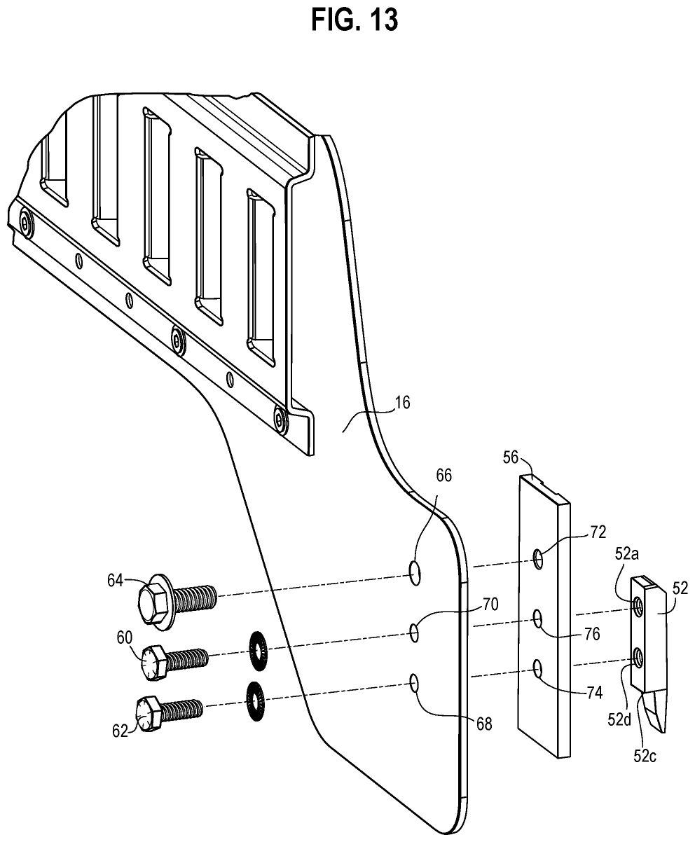

A support system 10 for supporting and securing a horizontal logistics track 12 to adjacent first and second vertical logistics posts 22, 24 mounted on a sidewall of a cargo compartment 86 is shown in FIGS. 1-16. While a support system 10 for use with a horizontal logistics track 12 is specifically described herein, the support system 10 may be configured and successfully implemented for use with other components of a logistics track system (e.g., other types of tracks) for supporting and securing the components to adjacent vertical logistics posts mounted on a sidewall of a cargo compartment. For the sake of brevity, a horizontal “E” style logistics track 12 disclosed herein is described and depicted as the component to be used with the support system 10, but one of ordinary skill in the art, with a thorough review of the subject specification and figures, will readily comprehend how the support system 10 may be implemented for use with other components for supporting and securing the other components to adjacent vertical logistics posts mounted on a sidewall of a cargo compartment and will readily comprehend which other components (e.g., “A” style track) might be suitable without undue experimentation.

Referring to FIGS. 1-4, the support system 10 may include a plate 20 having a first end section 14, a second end section 16, and a third section 18 extending between the first and second end sections 14, 16. The plate 20 may be configured to be capable of being secured to adjacent first and second vertical logistics posts 22, 24. The support system 10 may be used to provide an add-on horizontal logistics track 12 that can be easily attached and removed from the vertical logistics posts in a standard cargo van trailer wall. The plate 20 may be made of carbon steel or other suitable materials to provide the required securement strength and flexibility. The thickness of the plate 20 may be varied as desired and/or needed to provide the required securement strength. For example, in some embodiments, the thickness of the plate 20 may range from 0.060 inch to 0.190 inch, depending on the required securement strength.

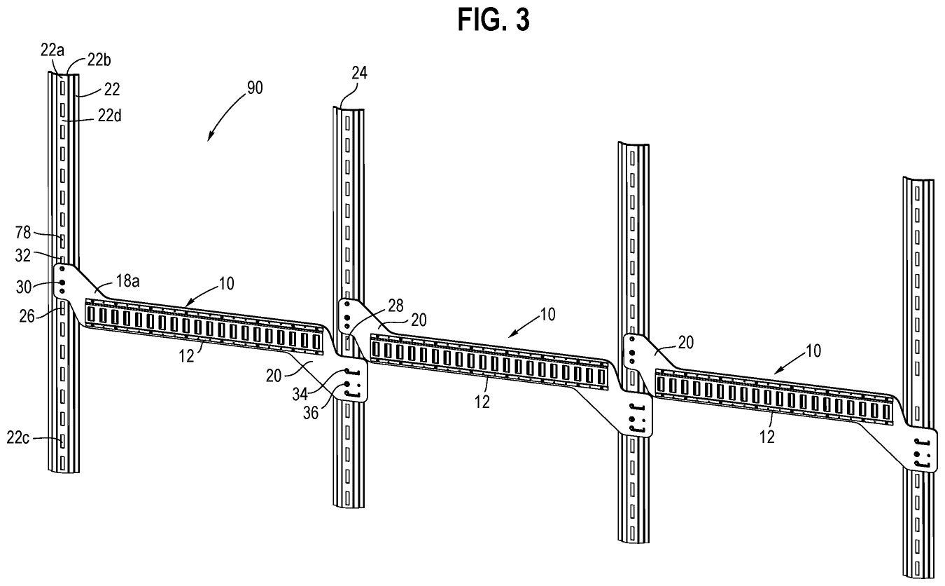

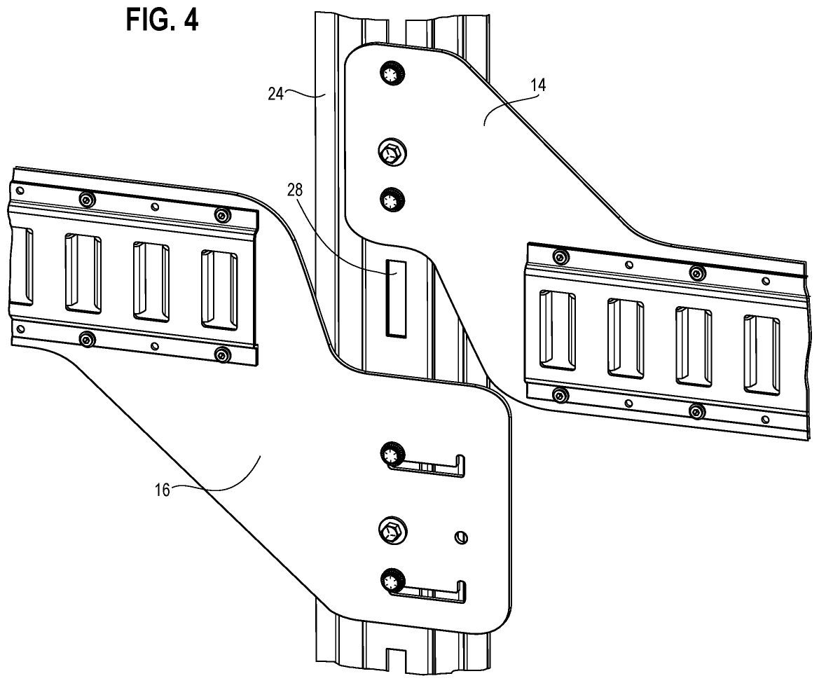

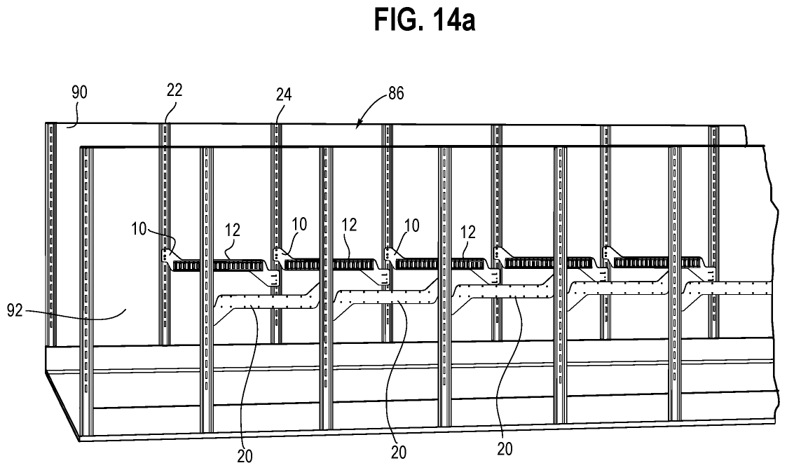

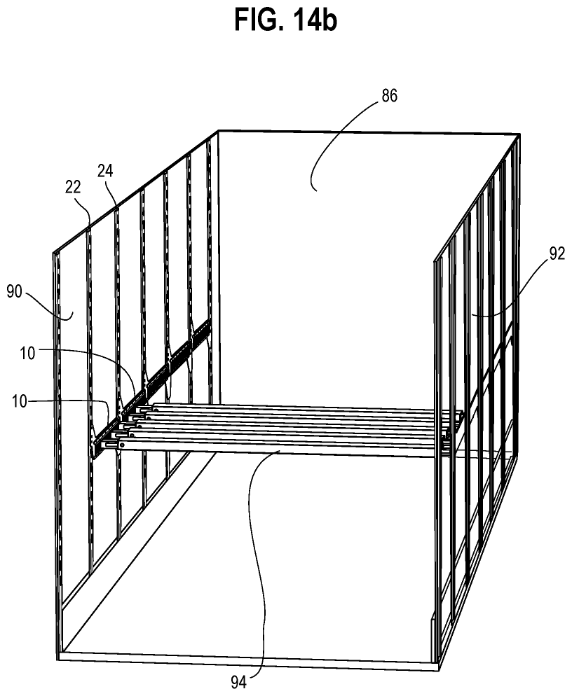

The vertical logistics posts may be one of a plurality of lengths of stationary logistics track, such as “A” or “E” track, which are well known in the art. The vertical logistics posts are normally rigidly mounted to the walls or floor of a cargo compartment, or to a storage facility. The vertical logistics post 22 may have a plurality of vertically aligned slots (e.g., 26, 30, 32) that extend from a front surface 22a of the vertical logistics post 22 and through the vertical logistics post 22 to a rear surface 22b of the vertical logistics post 22. The slots (e.g., 26, 30, 32) are disposed in a spaced relationship along the length of the vertical logistics post 22, such as at equal spacing from each other. As illustrated in FIGS. 3-4, the slots (e.g., 26, 30, 32) are oriented such that a long axis 22c of each slot is parallel with and, in some embodiments, coincident with a long axis of the vertical logistics post 22. In other embodiments (not illustrated), the long axis 22c of the slots are oriented at an angle to and, in some embodiments, substantially perpendicular (i.e., plus or minus 10 degrees from true perpendicular) to the long axis of the vertical logistics post 22. In some embodiments, the vertical logistics posts may be disposed in opposing pairs upon opposite walls 90, 92 of the cargo compartment 86 (e.g., as shown in FIGS. 14a and 14b). In some embodiments (e.g., as shown in FIGS. 3, 14a and 14b), a plurality of vertical logistics posts may be disposed upon each wall of the cargo compartment 86 to allow for flexibility in the arrangement of the storage equipment therewithin, which is releasably mounted to the vertical logistics posts for desired storage and transport purposes. In some embodiments, the vertical logistics post 22 may include a central portion 22d (the planar portion that includes the plurality of slots (e.g., 26, 30, 32) that is set forward of the opposed sides of the vertical logistics post 22 (which contact the mounting surface) to create a space behind the central portion 22d when the vertical logistics post 22 is mounted to a flat surface (e.g., the wall of the cargo compartment).

In some embodiments, the first end section 14 may be configured to be capable of being secured to the first vertical logistics post 22 and the second end section 16 may be configured to be capable of being secured to the second vertical logistics post 24. While the support systems 10 may be secured to adjacent vertical logistics posts mounted on each of the opposite sidewalls 90, 92 of a cargo compartment 86, for the sake of brevity, the configuration and securement of a single support system 10 to adjacent first and second vertical logistics posts 22, 24 will be discussed herein. One of ordinary skill in the art will understand that the support systems 10 secured to other adjacent vertical logistics posts mounted on the same sidewall as or the opposite sidewall from the support system 10 being discussed in detail herein may be configured and secured in the same manner.

The third section 18 may be configured such that a horizontal logistics track 12 may be secured to a front surface 18a of the third section 18 and disposed such that when the plate 20 is secured to adjacent first and second vertical logistics posts 22, 24, the horizontal logistics track 12 may extend horizontally between the adjacent first and second vertical logistics posts 22, 24. This configuration allows the horizontal logistics track 12 to provide securement attachment positions (e.g., a plurality of slots spaced along the length of the horizontal logistics track 12) in the space between the adjacent vertical logistics posts (e.g., 22, 24), such that when a pair of the plates 20 (and a pair of the horizontal logistics tracks 12 mounted on the third section 18) are secured to respective adjacent vertical logistics posts mounted on opposite sidewalls 90, 92 of a cargo compartment 86, beams 94 (e.g., shoring beams, decking beams) or cargo securement straps may extend between the vertical logistics posts mounted on the opposite sidewalls 90, 92 with ends secured to respective slots of the pair of horizontal logistics tracks (e.g., as shown in FIGS. 14a and 14b). It will be appreciated that, in some embodiments, the plate 20 may be configured such that when the first and second end sections 14, 16 are secured to the respective adjacent first and second vertical logistics posts 22, 24, the third section 18 (and the horizontal logistics tracks 12 mounted on the third section 18) may extend between the adjacent first and second vertical logistics posts 22, 24 at a desired and/or needed angle (e.g., not extending horizontally) relative to the vertical logistics posts 22, 24, without departing from the scope of the present invention.

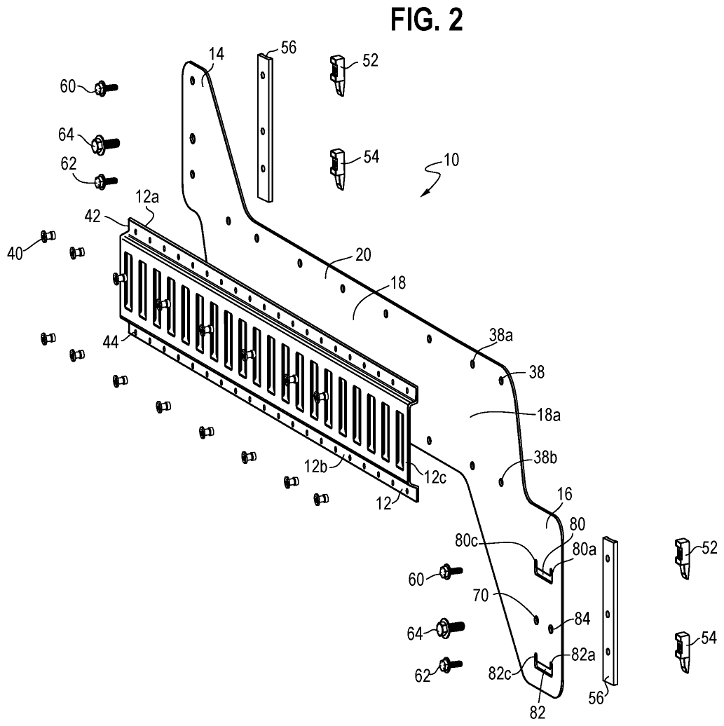

The third section may include at least one aperture 38 disposed on the front surface 18a of the third section 18 to receive at least one removable engagement device 40 that is used to couple the horizontal logistics track 12 to the front surface 18a of the third section 18. The at least one aperture 38 may be a blind aperture, through aperture, threaded aperture, or other variations. The at least one removable engagement device 40 may be a threaded fastener, a screw, a bolt, a pin (whether a standard or cotter-style pin with a locking device at either end of the pin), and other similar fasteners and engagement devices. In some embodiments, as shown in FIG. 2, the at least one aperture 38 may include a plurality of apertures 38 spaced along the length of the front surface 18a of the third section 18 to receive a plurality of corresponding removable engagement devices 40, such that the horizontal logistics track 12 may be secured to the third section 18 with the required securement strength.

It will be appreciated that the type, number and arrangement of the apertures 38 may be varied as desired and/or needed, depending on the type, number and arrangement of the corresponding apertures on the horizontal logistics track 12, such that the horizontal logistics track 12 may be secured to the third section 18 with a required securement strength. For example, in some embodiments, as shown in FIGS. 1-2, the horizontal logistics track 12 may include a first plurality of apertures 42 spaced along an upper edge 12a of the horizontal logistics track 12 and a second plurality of apertures 44 spaced along a lower edge 12b of the horizontal logistics track 12 with a plurality of slots horizontally aligned and spaced along a center portion 12c of the horizontal logistics track 12 that is disposed between the upper and lower edges 12a, 12b. In these embodiments, the at least one aperture 38 may include first and second sets of apertures 38a, 38b disposed upon the front surface 18a of the third section 18 such that the upper edge 12a may be secured to the third section 18 through the first plurality of apertures 42 and the first set of apertures 38a and the lower edge 12b may be secured to the third section 18 through the second plurality of apertures 44 and the second set of apertures 38b.

The configuration of the third section 18 may be varied as desired and/or needed to accommodate the configurations of varying components to be secured to the third section 18 and to provide the required securement strength. For example, in the embodiments where a horizontal logistics track 12 is to be secured to the third section 18 of the plate 20, the third section 18 may be formed with a length that is greater than the length of the horizontal logistics track 12 and with a width that is greater than the width of the horizontal logistics track 12. As shown in FIGS. 1-3, the third section 18 may be generally in the shape of a rectangle or a parallelogram to accommodate the generally rectangular shape of the horizontal logistics track 12. It will be appreciated that the dimension (e.g., length, width) and shape of the third section 18 may be varied as desired and/or needed, without departing from the scope of the present invention, but must be such that the components (e.g., the horizontal logistics track 12) to be secured to the third section 18 can be mounted to the third section 18 in a desired orientation to provide the required attachment positions upon the components (e.g., the horizontal logistics track 12) with required strength.

In some embodiments, the plate 20 may be configured such that when the first and second end sections 14, 16 are respectively secured to the adjacent first and second vertical logistics posts 22, 24, the third section 18 may extend horizontally between the first and second vertical logistics posts 22, 24 while leaving first and second slots 26, 28 of the respective first and second vertical logistics posts 22, 24 that are in line with the third section 18 open (e.g., as shown in FIGS. 3-4). In some embodiments, the plate 20 may have a generally Z-shaped configuration such that when the plate 20 is secured to the adjacent first and second vertical logistics posts 22, 24 with the third section 18 extending horizontally between the first and second slots 26, 28 of the respective adjacent first and second vertical logistics posts 22, 24, the first and second end sections 14, 16 are respectively secured to third and fourth slots 30, 34 that are disposed at different heights upon the respective adjacent first and second vertical logistics posts 22, 24.

For example, in some embodiments, the third slot 30 may be disposed adjacent to and above the first slot 26 in the first vertical logistics post 22, and the fourth slot 34 may be disposed adjacent to and below the second slot 28 in the second vertical logistics post 24. As for another example, in some embodiments (discussed in greater detail below), as shown in FIG. 3, the first end section 14 may be configured to be capable of being secured to both of the third slot 30 that is disposed adjacent to and above the first slot 26 and a fifth slot 32 that is disposed adjacent to and above the third slot 30, and the second end section 16 may be configured to be capable of being secured to both of the fourth slot 34 that is disposed adjacent to and below the second slot 28 in the second vertical logistics post 24 and a sixth slot 36 that is disposed adjacent to and below the fourth slot 34, such that greater strength of the attachment of the plate 20 (and thus the horizontal logistics track 12 mounted thereon) to the vertical logistics posts may be achieved such that the horizontal logistics track 12 may support normal beam and cargo securement strap loading.

This configuration allows the plates 20 (e.g., and the horizontal logistics track 12 mounted thereon) to be secured to successive adjacent vertical logistics posts without the need for using one half of the width of the slot upon the vertical logistics posts for each end of the plate 20. This provides the ability to achieve high strength of the attachment of the horizontal logistics track 12 to the vertical logistics posts, such that the horizontal logistics track 12 (which is easily attached to and removed from the vertical logistics posts) is suitable for supporting the cargo securement and cargo decking loads consistent with a permanently installed horizontal logistics track. The open first and second slots 26, 28 may be used for receiving a beam or cargo strap attachment.

It will be appreciated that the plate 20 may be configured such that when the first and second end sections 14, 16 are secured to respective adjacent first and second vertical logistics posts 22, 24, the first and second slots 26, 28 that are in line with the third section 18 are not open. For example, in some embodiments, the plate 20 may be configured such that the first end section 14 is capable of being secured to the first and third slots 26, 30 in the first vertical logistics post 22 and the second end section 16 is capable of being secured to the second and fourth slots 28, 34 in the second vertical logistics post 24. It will be appreciated that in these embodiments, the plates 20 (and the horizontal logistics tracks 12 mounted thereon) may still be secured to successive adjacent vertical logistics posts at the same height by using one half of the width of the slots that are in line with the third section 18 of the plate 20.

In some embodiments, as shown in FIGS. 1-4, the first edge 18b of the third section 18 may extend upwardly from the lower edge 18e of the third section 18 to a lower edge 14b of the first end section 14 at an angle φ relative to a plain through the lower edge 18e of the third section 18, such that a vertical distance 48 between the lower edge 14b and the plain through the lower edge 18e that is greater than a length of the slot in a vertical logistics post (e.g., 22) may be established. The second edge 18c of the third section 18 may extend downwardly from the upper edge 18d of the third section 18 to an upper edge 16b of the second end section 16 at an angle μ relative to a plain through the upper edge 18d of the third section 18, such that a vertical distance 50 between the upper edge 16b and the plain through the upper edge 18d that is greater than a length of a slot in a vertical logistics post (e.g., 24) may be established.

In some embodiments, the angle φ may be equal to the angle μ and the distance 48 may equal to the distance 50, while in other embodiments, they may be different. As shown in FIGS. 3-4, the angles φ, μ and the distances 48, 50 are configured to provide clearance for securing beams or cargo straps to the slots of the vertical logistics posts that are in line with the third section 18 when a plurality of plates 20 are secured to successive adjacent vertical logistics posts at the same height. It will be appreciated that the angles φ, μ and the distances 48, 50 may be varied as desired and/or needed, without departing from the scope of the present invention, such that the plate 20 may be secured to different slots and/or different combinations of slots in the adjacent vertical logistics posts.

In some embodiments, the first end section 14 may include a connecting edge 14a extending from a first position 18f on the upper edge 18d of the third section 18 to an upper edge 14c of the first end section 14 at an angle α relative to the plain through upper edge 18d. The second end section 16 may include a connecting edge 16a extending from a second position 18g on the lower edge 18e of the third section 18 to a lower edge 16c of the second end section 16 at an angle β relative to the plain through the lower edge 18e. The first and second positions 18f, 18g and the angles α, β may be varied as desired and/or needed such that the required strength of the attachment of the plate 20 (and the horizontal logistics track 12 mounted thereon) to the vertical logistics posts may be achieved.

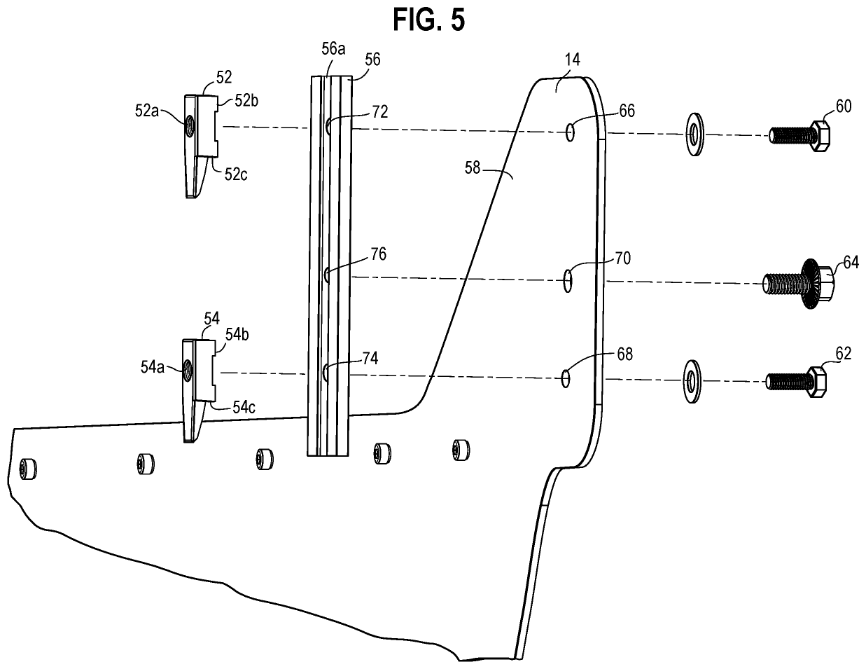

Referring to FIGS. 5-7, in some embodiments, at least one end of the support system 10 may include at least one adapter 52 coupled to a back surface 58 of at least one end section of the plate 20 through at least one adapter engagement device 60 that extends through at least one aperture disposed on the at least one end section of the plate 20. In some embodiments, the at least one end of the support system 10 may include a block 56 disposed between the at least one adapter 52 and the back surface 58 of the at least one end section of the plate 20. The at least one adapter 52 is configured to be received through at least one slot of a vertical logistics post such that the support system 10 may be secured to the vertical logistics post. The configuration and operation of the at least one adapter 52 is described in U.S. non-provisional application Ser. No. 15/899,538, titled “FLUSH MOUNT SUPPORT SYSTEM FOR CARGO COMPARTMENT LOGISTICS TRACK,” filed on Feb. 20, 2018 (Attorney Docket Number: 14594-789), which is hereby incorporated by reference in its entirety. In some embodiments, the at least one end of the support system 10 may include a locking engagement device 64 disposed for preventing the at least one adapter 52 from moving upwardly and disengaging from the at least one slot of the vertical logistics post that receives the at least one adapter 52.

In some embodiments, as shown in FIGS. 5-7, the at least one end of the support system 10 may include the first end section 14 of the plate 20, first and second adapters 52, 54, a block 56, first and second adapter engagement devices 60, 62, and a locking engagement device 64. It will be appreciated that the end of the support system 10 including the second end section 16 of the plate 20 may be configured in the same or different manner as the end including the first end section 14, and thus will not be specifically discussed herein for the sake of brevity. The first and second adapters 52, 54 each may include at least one apertures 52a, 54a. The first end section 14 may include three vertically aligned apertures 66, 68 and 70, and the block 56 may include three corresponding vertically aligned apertures 72, 74 and 76. The apertures 66 and 72 may be configured such that the first adapter 52 may be coupled to the first end section 14 through the first adapter engagement device 60 extending from a front surface 20a of the plate 20 through the apertures 66, 72 and 52a. The apertures 68 and 74 may be configured such that the second adapter 54 may be coupled to the first end section 14 through the second adapter engagement device 62 extending from the front surface 20a of the plate 20 through the apertures 68, 74 and 54a.

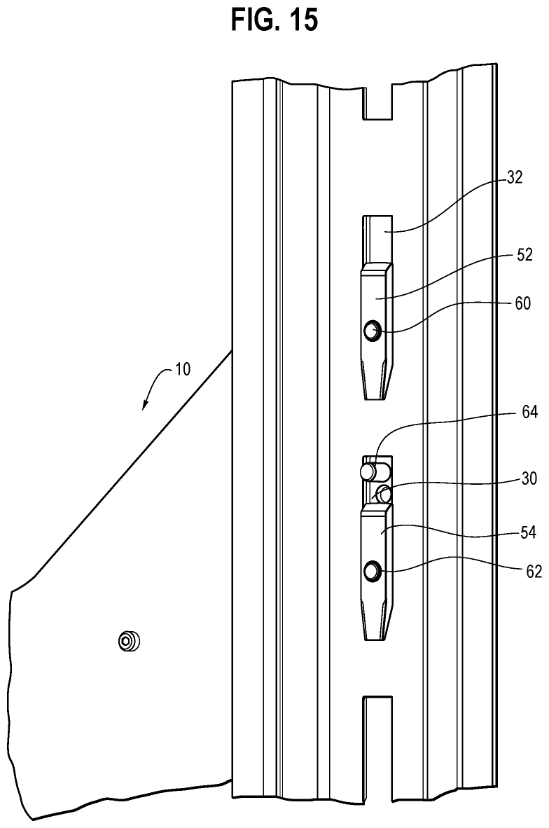

In some embodiments, as shown in FIG. 15, the first and second adapters 52, 54 may be disposed along a length of the first end section 14 such that when the first and second adapters 52, 54 each are received through respective third and fifth slots 30, 32 in the first vertical logistics post 22 with bottom edges 52c, 54c of the first and second adapters 52, 54 contacting the respective bottom edges of the third and fifth slots 30, 32, the locking engagement device 64 may be received through the third slot 30 with a small clearance disposed between the locking engagement device 64 and the upper edge of the third slot 30. A small amount upward movement of the first and second adapters 52, 54 will cause the locking engagement device 64 to contact the upper edge of the third slot 30, such that the first and second adapters 52, 54 are prevented from moving upwardly and disengaging from the respective third and fifth slots 30, 32. In some embodiments, the first and second adapter engagement devices 60, 62, and the locking engagement device 64 may be a threaded fastener, a screw, a bolt, a pin (whether a standard or cotter-style pin with a locking device at either end of the pin), and other similar fasteners and engagement devices.

In some embodiments, the block 56 may include a groove 56a extending along a length of the back surface of the block 56, such that when the first and second adapters 52, 54 are coupled to the block 56 with first and second adapter engagement devices 60, 62 extending through respective apertures 72, 52a and 74, 54a, both of the front surfaces 52b, 54b of the respective first and second adapters 52, 54 are received within the groove 56a such that the first and second adapters 52, 54 are prevented from rotating around respective axes of the apertures 52a, 54a and disengaging from the first end section 14.

It will be appreciated that the length of the first end section 14, the number of adapters, the number of apertures 52a in the at least one adapter 52, the number of the apertures 66, 68, 70 in the first end section 14, the number of corresponding apertures 72, 74 and 76 in the block 56, and the spacing between the apertures 66, 68 and 70 and the corresponding apertures 72, 74 and 76 may be varied as desired and/or needed such that the first end section 14 may be secured to different slots and/or combinations of slots in the first vertical logistics post 22 to achieve the desired securement strength.

For example, in some embodiments, the apertures 66, 68 and 70 in the first end section 14 and the corresponding apertures 72, 74 and 76 in the block 56 may be arranged such that when the first and second adapters 52, 54 each are received through respective third slot 30 and seventh slot 78 (adjacent to and above the fifth slot 32) in the first vertical logistics post 22 with the bottom edges 52c, 54c of the first and second adapters 52, 54 contacting the respective bottom edges of the third and seventh slots 30, 78, the locking engagement device 64 may be received through the fifth slot 32 with a small clearance disposed between the locking engagement device 64 and the upper edge of the fifth slot 32. A small amount of upward movement of the first and second adapters 52, 54 will cause the locking engagement device 64 to contact the upper edge of the fifth slot 32, such that the first and second adapters 52, 54 are prevented from moving upwardly and disengaging from the respective third and seventh slots 30, 78.

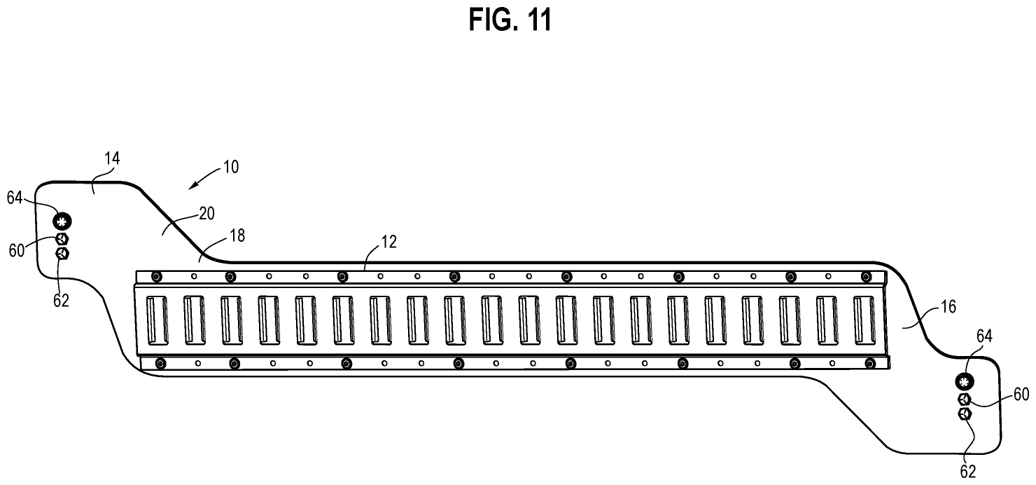

As for another example, in some embodiments, as shown in FIGS. 11-13, the at least one end of the support system 10 may include the second end section 16 of the plate 20, the first adapter 52, the block 56, the first and second adapter engagement devices 60, 62, and the locking engagement device 64. It will be appreciated that the end of the support system 10 including the first end section 14 of the plate 20 may be configured in the same or different manner as the end including the second end section 16. The first adapter 52 may include two apertures 52a, 52d that are vertically aligned. The second end section 16 may include three vertically aligned apertures 66, 70 and 68, and the block 56 may include three corresponding vertically aligned apertures 72, 76 and 74. The apertures 68, 70, 74 and 76 may be configured such that the first adapter 52 may be coupled to the second end section 16 through the first adapter engagement device 60 extending from the front surface 20a of the plate 20 through the apertures 70, 76 and 52a and the second adapter engagement device 62 extending from the front surface 20a of the plate 20 through the apertures 68, 74 and 52d. The apertures 66 and 72 may be configured to allow the locking engagement device 64 to extend therethrough and be coupled thereto.

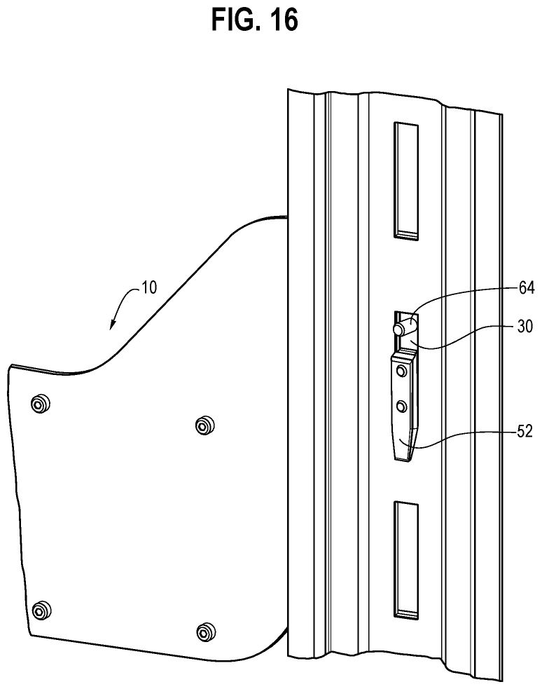

In some embodiments, as shown in FIG. 16, the apertures 66, 68, 70, 72, 74 and 76 are arranged such that when the first adapter 52 is received through the third slot 30 in the first vertical logistics post 22 with the bottom edge 52c of the first adapter 52 contacting the bottom edge of the third slot 30, the locking engagement device 64 may be received through the third slot 30 with a small clearance disposed between the locking engagement device 64 and the upper edge of the third slot 30. A small amount upward movement of the first adapter 52 will cause the locking engagement device 64 to contact the upper edge of the third slot 30, such that the first adapter 52 is prevented from moving upwardly and disengaging from the third slot 30. This configuration provides the ability to secure the support system 10 to a single slot in each of the adjacent vertical logistics posts. It will be appreciated that the configuration of the second end section 16 and the first adapter 52, and the number and arrangement of the apertures 66, 68, 70, 72, 74, 76, 52a, and 52d may be varied as desired and/or needed such that the support system 10 may be secured to a different single slot in each of the adjacent vertical logistics posts.

It will be appreciated that the support system 10 may be configured (e.g., the length of the plate 20) to accommodate the spacing between adjacent vertical logistics posts. For example, the support system 10 may be configured such that the adapter(s) coupled to respective first and second end sections 14, 16 may be received through the slot(s) in the respective adjacent first and second vertical logistics posts 22, 24. In some embodiments, the adjacent first and second vertical logistics posts 22, 24 may be spaced apart with centerlines that are about 48 inches apart, while in other embodiments, the adjacent first and second vertical logistics posts 22, 24 may be spaced apart with centerlines that are about 24 or 50 inches apart. The term “about” is specifically defined herein to include the specific value referenced as well as a dimension that is within 5% of the dimension both above and below the dimension.

In some embodiments, the support system 10 may be configured such that the plate 20 is capable of being secured to adjacent first and second vertical logistics posts 22, 24 that are spaced apart with centerlines that are different distances apart. For example, a single support system 10 may be configured such that the plate 20 is capable of being secured to adjacent first and second vertical logistics posts 22, 24 that are spaced apart with centerlines that are either about 48 inches or about 50 inches apart.

In these embodiments, as shown in FIGS. 1-2, 8-10, at least one of the end sections 14, 16 may include at least one slot 80 including a body 80b and at least two grooves 80a, 80c that each extend upwardly from the two ends of the body 80b. The body 80b and the at least two grooves 80a, 80c are configured and positioned such that an adapter engagement device 60 may extend through and slide along the length of the body 80b and be received through the at least two grooves 80a, 80c, such that the adapter 52 coupled to the adapter engagement device 60 may slide along the length of the body 80b, thereby allowing the support system 10 to be secured to adjacent first and second vertical logistics posts 22, 24 that are spaced apart with centerlines that are either about 48 inches (e.g., when the adapter engagement device 60 is received through the first groove 80c) or about 50 inches (e.g., when the adapter engagement device 60 is received through the second groove 80a) apart. At least two apertures 70, 84 may be provided in the at least one of the end sections 14, 16 and be vertically aligned with the respective at least two grooves 80a, 80c, such that the locking engagement device 64 may extend through a corresponding aperture 70 or 84 to prevent the adapter 52 from moving upwardly and disengaging from the slot of the vertical logistics post that receives through the adapter 52, when the support system 10 is used for adjacent first and second vertical logistics posts 22, 24 that are spaced apart with centerlines that are either about 48 inches or about 50 inches apart.

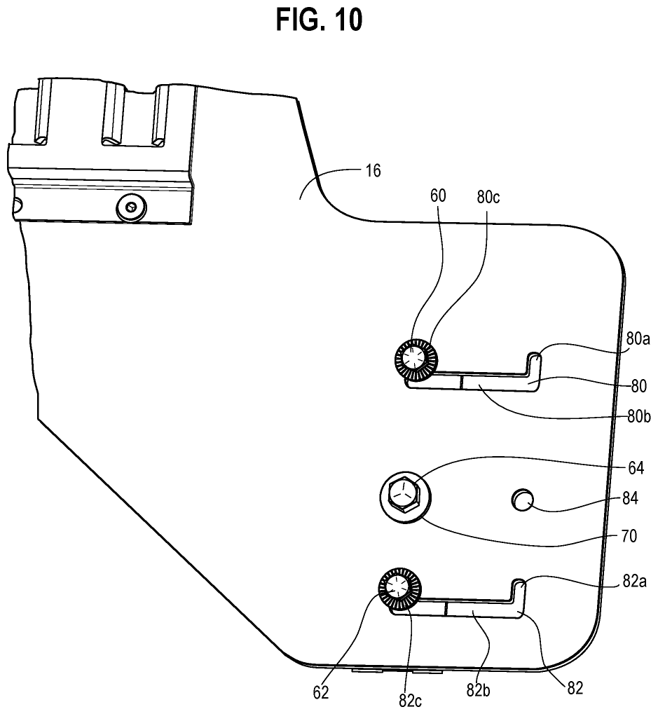

It will be appreciated that the configuration, number, and arrangement of the body 80b and the at least two grooves 80a, 80c may be varied as desired and/or needed to accommodate the adapter(s) and adapter engagement device(s) coupled to the at least one of the end sections 14, 16. For example, in some embodiments, as shown in FIG. 10, the second end section 16 may include two slots 80, 82 for respectively receiving the first and second adapter engagement devices 60, 62 that are respectively coupled to the first and second adapters 52, 54. The second slot 82 may be configured in the same manner as the first slot 80.

In use, to secure the support system 10 (e.g., the embodiment as shown in FIG. 1) to adjacent first and second vertical logistics posts 22, 24 that are spaced apart with centerlines that are about 48 inches apart, for each end of the support system 10, the user may extend the first and second adapter engagement devices 60, 62 through the respective first grooves 80c, 82c of the first and second slots 80, 82, couple the block 56, from the back surface 58, to the first and second adapter engagement devices 60, 62, and then couple the first and second adapters 52, 54 to the respective first and second adapter engagement devices 60, 62, such that the block 56 is disposed between the first and second adapter engagement devices 60, 62 and the first and second adapters 52, 54. The user may extend the locking engagement device 64 through the aperture 70 to the extent that the locking engagement device 64 does not extend through the block 56 (if the locking engagement device 64 is already coupled to the aperture 70 and extend through the block 56, the user may retract the locking engagement device 64 such that it does not extend through the block 56 before securing the support system 10 to the adjacent vertical logistics posts).

Then the user may engage each end of the support system 10 into respective two slots (e.g., slots 30, 32 in the first vertical logistics post 22 and slots 34, 36 in the second vertical logistics post 24) in each of the adjacent first and second vertical logistics posts 22, 24. Then the user may lower the support system 10 such that the bottom edges 52c, 54c of the adapters 52, 54 coupled to each of the end sections 14, 16 of the plate 20 rest upon the bottom edges of the respective slots they are received through, such that the third section 18 (and the horizontal logistics track 12 mounted thereon) is level. Then the user may secure the locking engagement device 64 to the plate 20 by further extending it through the block 56, such that the locking engagement device 64 on each end of the support system 10 extends through a respective slot (e.g., the slots 30, 36) in the first and second vertical logistics posts 22, 24, thereby preventing the first and second adapters 52, 54 from moving upwardly and disengaging from the respective slots in the vertical logistics posts.

To prepare the support system 10 (e.g., the embodiment as shown in FIG. 1) to be capable of being secured to adjacent first and second logistics posts that are spaced with centerlines that are about 50 inches apart, for each end of the support system 10, the user may remove the locking engagement device 64, loosen the first and second adapter engagement devices 60, 62, and slide the first and second adapter engagement devices 60, 62 and the first and second adapters 52, 54 respectively coupled thereto from the first grooves 80c, 82c to the second grooves 80a, 82a through the respective first and second slot bodies 80b, 82b. Then the user may retighten the first and second adapter engagement devices 60, 62 and re-install the locking engagement device 64, such that the support system 10 may be secured to adjacent vertical logistics posts with centerlines that are about 50 inches apart. One of ordinary skill in the art, with a thorough review of the subject specification and figures, will readily comprehend how to reposition the adapters such that the support system 10 suitable for being secured to adjacent vertical logistics posts with centerlines that are about 50 inches apart may be suitable for being secured to adjacent vertical logistics posts with centerlines that are about 48 inches apart.

While a method for securing the support system 10 (e.g., the embodiment as shown in FIG. 1) with two adapters coupled to each end of the plate 20 for engaging two slots in each of the adjacent vertical logistic posts that are spaced with centerlines that are about 48 inches apart is specifically described herein, one of ordinary skill in the art, with a thorough review of the subject specification and figures, will readily comprehend how the support system 10 with different configurations (e.g., different numbers of the adapters coupled to each end of the plate 20 for engaging one slot or more than two slots in each of the adjacent vertical logistic posts that are spaced with centerlines that are different distances apart) may be secured to adjacent vertical logistics posts mounted on a sidewall of a cargo compartment without undue experimentation.

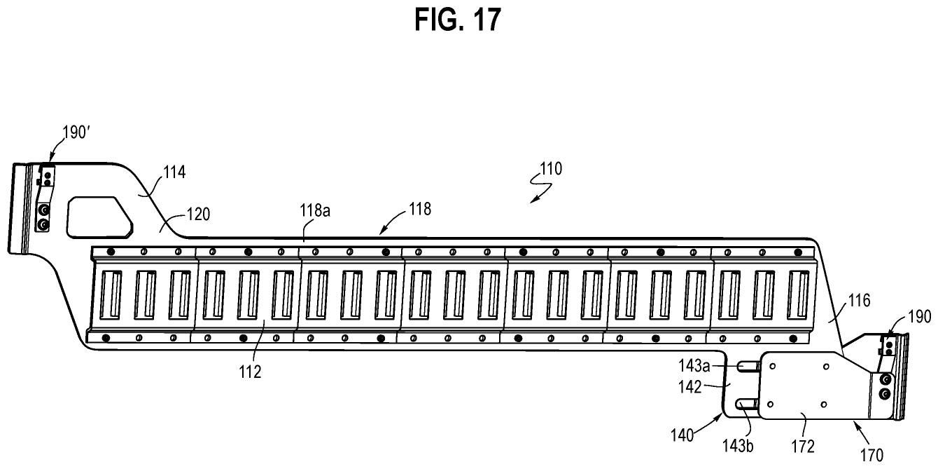

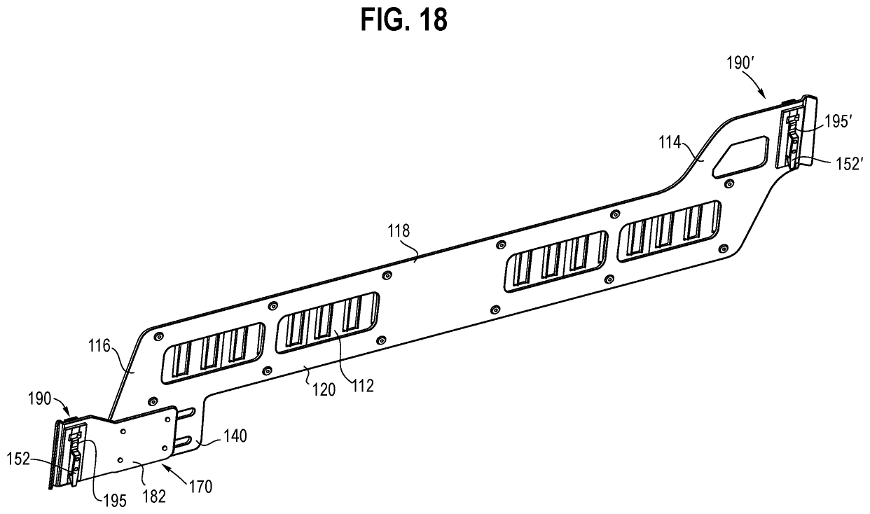

Referring now to FIGS. 17-20, an alternative embodiment of a support system 110, in accordance with certain aspects of the present disclosure, is shown and described. The support system 110 is similar in certain respects to the support system 10, and common reference numerals may designate similar parts, e.g., the logistics track 12 of FIGS. 1-16 may be similar or identical to the logistics track 112 of FIGS. 17-20, with main exceptions to the design of FIGS. 17-20 being noted in further detail below.

The support system 110 is used for supporting and securing a horizontal logistics track 112 to adjacent first and second vertical logistics posts, such as the vertical logistic posts 22 and 24 mounted on a sidewall of the cargo compartment 86, as referenced in FIGS. 3, 14A and 14B, above. A first end section 114 of a plate 120 may be configured to be secured to the first vertical logistics post 22 and a second end section 116 of the plate 120 may be configured to be secured to the second vertical logistics post 24. A third section 118 may be configured such that the horizontal logistics track 112 may be secured to a front surface 118a of the third section 118 and disposed such that when the plate 120 is secured to adjacent first and second vertical logistics posts 22, 24, the horizontal logistics track 112 may extend horizontally between the adjacent first and second vertical logistics posts 22, 24. Similar to the embodiment of FIGS. 1-16, this configuration allows the horizontal logistics track 112 to provide securement attachment positions (e.g., a plurality of slots spaced along the length of the horizontal logistics track 112) in the space between the adjacent vertical logistics posts (e.g., 22, 24). When a pair of the plates 120 (and a pair of the horizontal logistics tracks 112 mounted on the third section 118) are secured to respective adjacent vertical logistics posts mounted on opposite sidewalls 90, 92 of a cargo compartment 86, beams 94 (e.g., shoring beams or decking beams) or cargo securement straps may extend between opposite sidewalls 90, 92 with ends secured to respective slots of the pair of horizontal logistics tracks 112 (e.g., as generally depicted in FIGS. 14a and 14b).

In the embodiment of FIGS. 17-20, the second end section 116 of the plate 120 comprises an expansion joint 140, which advantageously allows the ability to quickly and easily adjust usage when vertical logistics posts 22, 24 are different distances apart, such as 48 inches versus 50 inches, as explained further below. In one embodiment, the expansion joint 140 comprises a movable segment 170 that is capable of generally horizontal movement with respect to the horizontal logistics track 112. In one example, the movable segment 170 may slide along a track disposed on a portion of the second end section 116.

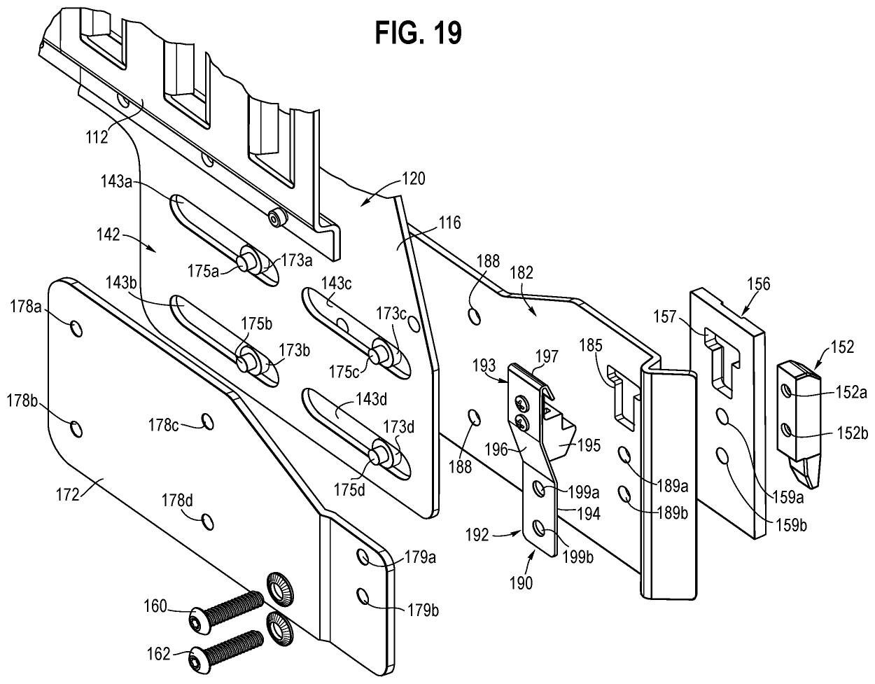

In the embodiment depicted, the second end section 116 comprises a guide segment 142, which is generally disposed vertically beneath the horizontal logistics track 112 and to the right side (when viewed from the front), as best seen in FIG. 17. The guide segment 142 comprises at least one track, and in the example shown herein comprises four different tracks 143a-143d, as best seen in the exploded view of FIG. 19. It will be appreciated that while four different tracks 143a-143d are depicted in FIGS. 17-20, greater or fewer tracks may be provided while still accomplishing the objectives of the present embodiments. Moreover, while the four different tracks 143a-143d are depicted in the form of slots disposed through a surface of the guide segment 142, it will be appreciated that other tracks may be employed, such as rails or notches that may or may not form a slot fully through the guide segment 142.

The movable segment 170 is coupled to the guide segment 142 such that it is capable of generally horizontal movement with respect to the guide segment 142, and consequently the horizontal logistics track 112. In one non-limiting example, the movable segment 170 comprises a front plate 172 and a rear plate 182, as best seen in FIG. 19. When assembled, the front plate 172 is generally disposed in front of the guide segment 142 of the second end section 116, while the rear plate 182 is generally disposed behind the guide segment 142.

At least one shaft may be coupled to the front plate 172 and/or the rear plate 182 to facilitate movement of the movable segment 170 with respect to the guide segment 142. In the non-limiting example of FIGS. 17-20, four different shafts 173a-173d are provided, such that each shaft 173a-173d is disposed for movement with respect to a corresponding track 143a-143d, as best seen in FIG. 19. The shafts 173a-173d may comprise any suitable shaft-like member, whether it is fixed in movement, capable of rolling, comprises a uniform diameter, has enlarged or reduced ends, rivet-like features, or other characteristics of shaft-like members. In this example, four protrusions 175a-175d may be associated with a respective shaft 173a-173d, where each protrusion 175a-175d extends both forward and rearward of its respective shaft 173a-173d. The forward extending portion of protrusion 175a may be disposed through an aperture 178a formed in the front plate 172, while the forward portions of protrusions 175b-175d may similarly be disposed through respective apertures 178b-178d formed in the front plate 172. Similarly, rearward extending protrusions may be disposed through four corresponding apertures 188 formed in the rear plate 182. In this manner, when the front plate 172 and the rear plate 182 are held adjacent to one another on opposing sides of the guide segment 142, the front and rear plates 172 and 182 may collectively move together in a generally horizontal direction by movement of the shafts 173a-173d moving within their respective tracks 143a-143d.

The support system 110 of FIGS. 17-20 further comprises at least one adapter 152, a block 156 disposed between the at least one adapter 152 and the rear plate 182, and a spring loaded keeper 190, which are best seen in the exploded view of FIG. 19. In one embodiment, the at least one adapter 152 is similar to the adapter 52 described in detail above, and the block 156 is similar to the block 56, with notable exceptions described below.

The spring loaded keeper 190 comprises a first region 192 and a second region 193, where in use the second region 193 is disposed generally vertically above the first region 192. A locking block 195 may be disposed adjacent to a rear surface 194 of the spring loaded keeper 190, as best seen in FIG. 19. When assembled, the locking block 195 is configured to extend through an opening 185 disposed through the rear plate 182, and further is configured to extend through an opening 157 of the block 156. In use, the locking block 195 of the spring loaded keeper 190 is configured to engage an upper edge of a slot in the vertical logistics posts 22, 24. A small amount of upward movement of the first adapter 152 will cause the locking block 195 to contact the upper edge of the associated slot, such that the first adapter 152 is prevented from moving upwardly and disengaging from the associated slot.

The spring loaded keeper 190 further comprises a tapered region 196 disposed between the first and second regions 192 and 193, and an interface 197 disposed near the end of the second region 193, as best seen in FIG. 19. In use, when an operator pulls the interface 197 in a rearward to forward direction, the tapered region 196 provides a spring-like resistance that can be overcome with sufficient force, thereby allowing the locking block 195 to also move in the rearward to forward direction, and disengage from an associated slot. However, in the absence of external forces, the spring loaded keeper 190 may be biased towards a rearward position to keep the locking block 195 biased towards an associated slot in the vertical logistics post.

The front plate 172, the rear plate 182, the spring loaded keeper 190, the block 156 and the at least one adapter 152 may be held adjacent to one another by one or more engagement devices 160, 162, such as a screw, a bolt, a pin (whether a standard or cotter-style pin with a locking device at either end of the pin), and other similar fasteners. When assembled, the engagement device 160 may extend through a first aperture 179a of the front plate 172, through a first aperture 199a of the spring loaded keeper 190, through a first aperture 189a of the rear plate 182, through a first aperture 159a of the block 156, and through a first aperture 152a of the first adapter 152. Similarly, when assembled, the engagement device 162 may extend through a second aperture 179b of the front plate 172, through a second aperture 199b of the spring loaded keeper 190, through a second aperture 189b of the rear plate 182, through a second aperture 159b of the block 156, and through a second aperture 152b of the first adapter 152.

The support system 110 of FIGS. 17-20 provides several advantages, including those already discussed above with respect to the embodiment of FIGS. 1-16. As one particular advantage, the support system 110 provides a simple system by which the horizontal logistics track 112 can be quickly and easily modified for use in a trailer where vertical logistics posts are positioned at different distances relative to one another. For example, the support system 110 can be operated in a first position with vertical logistics posts 22, 24 spaced about 48 inches apart when the movable segment 170 comprising the shafts 173a-173d are moved inwardly within their respective tracks 143a-143d, i.e., closer to the center of the plate 120. At this time, the first adapter 152 of the movable segment 170 will be positioned closer to a second adapter 152′ that is disposed at the first end section 114 of the system 110, and aligned with a slot of the vertical logistics post that is spaced about 48 inches apart from another slot. Forces on the spring loaded keeper 190 are released to allow a biased engagement of the locking block 195 of the spring loaded keeper 190 with the associated slot.

If a user desires to then use the support system 110 in a second position with vertical logistics posts 22, 24 spaced about 50 inches apart, then the interface 197 on the spring loaded keeper 190 may be moved in a rearward to forward direction, thus overcoming the spring biased force and releasing the locking block 195 from its original slot. Then, the movable segment 170 and associated the shafts 173a-173d may be moved in a horizontally outward direction within their respective tracks 143a-143d, i.e., away from the center of the plate 120. At this time, the first adapter 152 of the movable segment 170 will be positioned further from the second adapter 152′. When the first adapter 152 is aligned with the new slot of the vertical logistics post that is spaced about 50 inches apart from the adjacent slot, the first adapter 152 and the spring loaded keeper 190 are then engaged with the new associated slot.

In short, by simple movements of the movable segment 170 with respect to the guide segment 142 (and the horizontal logistics track 142), a user can easily adapt the support system 110 for use with vertical logistics posts 22, 24 that are different distances apart. It will be appreciated that a horizontal distance of the tracks 143a-143d is a greater length than the adjustment distance (e.g., the tracks are at least 2 inches long when an adjustment is being made from a 48″ usage distance to a 50″ usage distance), thereby allowing the movable segment 170 to traverse the required adjustment distance.

As a further advantage of the support system 110, the spring loaded keeper 190 avoids the requirement for locking bolts and tools to retain the ends of the support system 110 into the slots of the vertical logistics posts 22, 24. Notably, the spring loaded keeper 190 is retained with the movable segment 170 before, during and after usage of the support system 110, including for use with vertical logistics posts 22, 24 at different distances. The resiliency of the spring loaded keeper 190, with its ability for the locking block 195 to selectively engage the upper edge of an associated slot in the vertical logistics posts 22, 24, can replace a component such as a separate locking engagement device, such as component 64 above, that must be extended through the block 56 to an engagement state and later removed when an adjustment is desired. In short, unlike other components that may require tools or components such as bolts that are removable and may be lost, the spring loaded keeper 190 may offer a simpler locking engagement system.

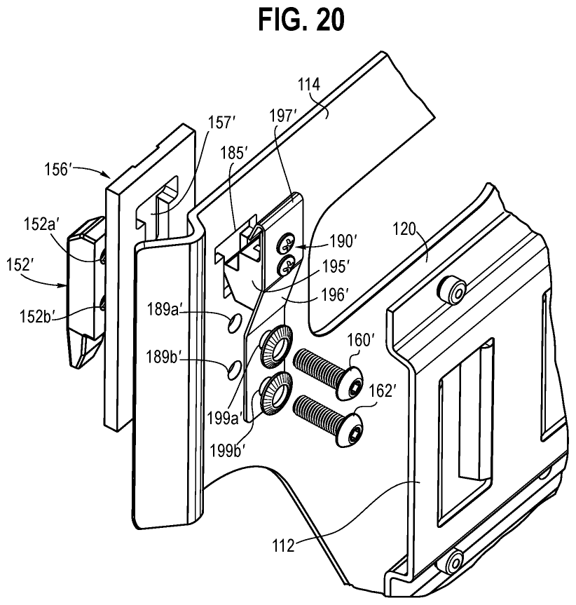

While a spring loaded keeper 190 has been described for use on the movable segment 170, which is adjacent the second end section 116 of the plate 120, it will be appreciated that a similar or identical spring loaded keeper 190′ may be used at the first end section 114 of the plate 120, as depicted in FIGS. 17-20. As best seen in FIG. 20, the spring loaded keeper 190′ comprises a locking block 195′, tapered region 196′ and interface 197′ that are identical to the locking block 195, tapered region 196, and interface 197, respectively, as described above for the spring loaded keeper 190. When assembled, a first engagement device 160′ may extend through a first aperture 199a′ of the spring loaded keeper 190′, through a first aperture 189a′ of the first end section 114, through a first aperture of the block 156′, and through a first aperture 152a′ of the first adapter 152′. Similarly, when assembled, a second engagement device 162′ may extend through a second aperture 199b′ of the spring loaded keeper 190′, through a second aperture 189b′ of the first end section 114, through a second aperture of the block 156′, and through a second aperture 152b′ of the first adapter 152′. In this manner, the spring loaded keeper 190′ encompasses the same advantages noted above with respect to the first spring loaded keeper 190, such as facilitating a secure engagement with an associated slot of the vertical logistics post, while omitting the need for tools or components such as bolts that are removable and may be lost.

While various embodiments of the present disclosure have been described, the present disclosure is not to be restricted except in light of the attached claims and their equivalents. One skilled in the relevant art will recognize that numerous variations and modifications may be made to the embodiments described above without departing from the scope of the present invention, as defined by the appended claims. Moreover, the advantages described herein are not necessarily the only advantages of the present disclosure and it is not necessarily expected that every embodiment of the present disclosure will achieve all of the advantages described.

We claim:

1. A plate for securing to adjacent first and second vertical logistics posts, comprising:
a first end section;
a second end section;
a third section extending between the first and second end sections; and
a track secured to the third section,
wherein the plate is configured such that when the plate is secured to adjacent first and second vertical logistics posts, the third section extends horizontally between first and second slots of the respective adjacent first and second vertical logistics posts, the first end section is secured to a third slot disposed adjacent to and above the first slot in the first vertical logistics post, and the second end section is secured to a fourth slot disposed adjacent to and below the second slot in the second vertical logistics post.

2. The plate of claim 1, wherein at least one of the first and second end sections is configured such that the plate is capable of being secured to adjacent first and second vertical logistics posts that are spaced apart with centerlines that are different distances apart.

3. The plate of claim 2, wherein a movable segment is disposed at the second end section and capable of generally horizontal movement with respect to the first end section and the third section.

4. The plate of claim 3, wherein the movable segment comprises at least one plate coupled to at least one shaft that is movable along a track of the second end section.

5. The plate of claim 1, wherein at least one of the first and second end sections is configured such that the plate is capable of being secured to adjacent first and second vertical logistics posts that are spaced apart with centerlines that are either about 48 inches or about 50 inches apart.

6. The plate of claim 1, wherein at least one of the first and second end sections comprises at least one slot such that the plate is capable of being secured to adjacent first and second vertical logistics posts that are spaced apart with centerlines that are different distances apart.

7. The plate of claim 6, wherein the at least one slot is configured such that at least one adapter is movable along a length of the at least one slot such that the plate can be secured to adjacent first and second vertical logistics posts that are spaced apart with centerlines that are different distances apart.

8. The plate of claim 7, wherein the at least one slot comprises at least two grooves for receiving at least one adapter engagement device coupled to the at least one adapter such that the plate can be secured to adjacent first and second vertical logistics posts that are spaced apart with centerlines that are two different distances apart.

9. The plate of claim 1, wherein the first end section is secured to the first and third slots of the first vertical logistics post, and the second end section is secured to the second and fourth slots of the second vertical logistics post.

10. The plate of claim 1, wherein the first and second end sections each comprise at least one adapter configured to be received through at least one slot of respective adjacent first and second vertical logistics posts, such that the plate is capable of being secured to the adjacent first and second vertical logistics posts that are spaced apart with centerlines that are different distances apart.

11. The plate of claim 10, wherein the first and second end sections each comprise at least one spring loaded keeper having a locking block configured to be received through the at least one slot of respective adjacent first and second vertical logistics posts and engage an upper edge of the at least one slot.

12. The plate of claim 11, wherein the at least one spring loaded keeper comprises a fixed lower region, a tapered central region, and a movable upper region.

13. The plate of claim 10, wherein the first and second end sections each comprise at least one locking engagement device configured to be received through the at least one slot of respective adjacent first and second vertical logistics posts and engage an upper edge of the at least one slot such that the at least one adapter received through the at least one slot is prevented from moving upwardly and disengaging from the at least one slot.

14. A plate for supporting and securing a track to adjacent first and second vertical logistics posts, wherein the plate is configured such that the plate is capable of being secured to adjacent first and second vertical logistics posts while leaving first and second slots of the respective adjacent first and second vertical logistics posts that are in line with a third section of the plate open.

15. The plate of claim 14, wherein the plate has a generally Z-shaped configuration.

16. The plate of claim 14, wherein when the plate is secured to the adjacent first and second vertical logistics posts, the first and second slots of the respective adjacent first and second vertical logistics posts that are in line with the third section of the plate are open for receiving a beam or cargo strap attachment.

17. The plate of claim 14, wherein the plate comprises a first end section and a second end section, wherein the third section extends between the first and second end sections, and wherein the third section is configured such that a track can be secured to the third section and be disposed horizontally when the plate is secured to the adjacent first and second vertical logistics posts.

18. The plate of claim 17, wherein when the plate is secured to the adjacent first and second vertical logistics posts, the first end section is secured to a third slot in the first vertical logistics post, and the second end section is secured to a fourth slot in the second vertical logistics post, and wherein the third slot is disposed adjacent to and above the first slot in the first vertical logistics post, and the fourth slot is disposed adjacent to and below the second slot in the second vertical logistics post.

19. A plate for securing to adjacent first and second vertical logistics posts, comprising:
a first end section;
a second end section;
a third section extending between the first and second end sections; and
a track secured to the third section,
wherein at least one of the first and second end sections is configured such that the plate is capable of being secured to adjacent first and second vertical logistics posts that are spaced apart with centerlines that are different distances apart, and
wherein a movable segment is disposed at the second end section and capable of generally horizontal movement with respect to the first end section and the third section.

20. The plate of claim 19, wherein the movable segment comprises at least one plate coupled to at least one shaft that is movable along a track of the second end section.
